(19) United States
(12) Patent Application Publication
(10) Pub. No.: US 2020/0353804 A1
(43) Pub. Date: Nov. 12, 2020

(54) VEHICLE COVER

(71) Applicant: RAFAEL FLORES, Charleston, SC (US)

(72) Inventor: RAFAEL FLORES, Charleston, SC (US)

(21) Appl. No.: 16/403,690

(22) Filed: May 6, 2019

(51) Int. Cl. B60J 11/02; B60J 11/04

(52) U.S. Cl. CPC B60J 11/025; B60Y 2200/14; B60J 11/04

(57) ABSTRACT

A cover usable with a vehicle furls and unfurls (rolls and unrolls) about a roller of a roller construct. The roller construct slides on a track that is mounted to the vehicle. In a first position, the cover is unrolled to cover a portion of the vehicle, such as a bed of a truck. In a second position, the roller construct slides outwardly and beyond a side of the vehicle to provide cover to an exterior portion on a side of the vehicle. Articulating support members are connected to the cover to support and hold an end of the cover that is opposite the roller construct.

### BACKGROUND OF THE INVENTION

Covers are useful for covering vehicles, such as trucks that have beds. Covers may be used to protect a vehicle or items placed in a bed of a vehicle from sun or weather. Covers also prevent objects from being displaced from the vehicle due to wind, particularly wind induced by travel at highway speeds.

Covers may include awnings that extend beyond a side of the vehicle. A cover used in this manner may be used to provide weather protection during activities such as camping, tailgating or other outdoor activities where the vehicle is used as a base. Pickup trucks are frequently used in conjunction with construction activities. A cover may be used to provide shade for construction workers during breaks and at meal times.

There is a need for a cover having functionality to cover a portion of a vehicle, such as a bed of a truck, but which has sufficient versatility to provide shade or other weather protection along an exterior side of a vehicle.

### SUMMARY OF THE INVENTION

The present invention is a cover that is usable with a vehicle. A roller construct comprises a cover that furls and unfurls (rolls and unrolls) about a roller of the roller construct. The roller construct slides on a track that is mounted to the vehicle.

In a first position, the cover is unrolled to cover a portion of the vehicle, such as a bed of a truck. Articulating support members that are spaced apart from the roller construct receive and hold the cover at a height above the vehicle that is determined by the user.

In a second position, the roller construct slides outwardly and beyond a side of the vehicle to provide covering at an exterior side of the vehicle. The support members articulate to the side of the vehicle. The support members are connected to the cover to support and hold an end of the cover that is opposite the roller construct.

When the cover is no longer needed, the cover is disconnected from the support members and the cover is rolled or furled about the roller of the roller construct. The support members are repositioned to not extend beyond the side or exterior of the vehicle.

### BRIEF DRAWING DESCRIPTION

FIG. 1 is a side elevation of the vehicle cover mounted to a pickup truck.

FIG. 2 is an isolation showing a partial view of a support member exploded away from a bed of a pickup truck.

FIG. 3 is an isolation of a length adjustable support member according to an embodiment of the invention.

FIG. 4 is a rear elevation of a vehicle showing spaced apart length adjustable support members and demonstrating alternate positions of the cover as a phantom.

FIG. 5 is a perspective view showing the roller construct moved from the position shown in FIG. 4 to a side of the vehicle, with a length adjustable support member and a second length adjustable support member mounted adjacent to each other and near a rear of the truck.

FIG. 6 demonstrates a housing in which the track and rollers construct may be positioned.

FIG. 7 demonstrates lateral movement of the roller construct relative to a track that is contained within a housing.

### DESCRIPTION OF PREFERRED EMBODIMENTS

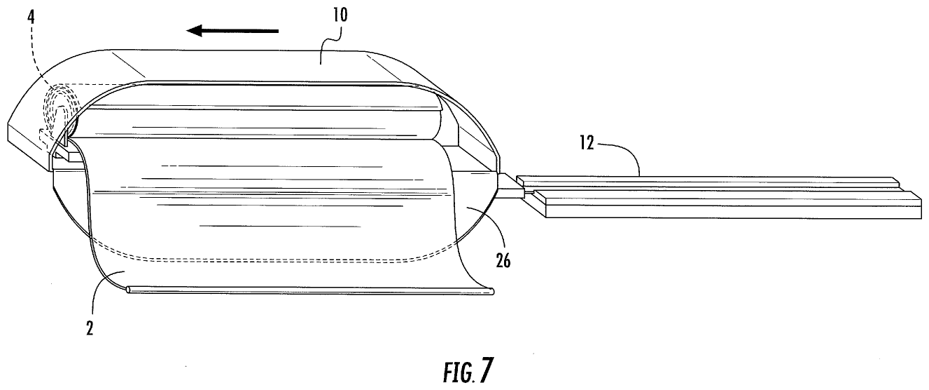

As shown in FIG. 7, the present invention comprises a cover 2 on a roller construct. The roller construct includes a roller 4 that rolls relative to the remainder of the roller construct. The cover rolls upon itself on the roller so that the roller construct retains the cover. The cover rolls and unrolls (furls and unfurls) relative to the roller. As the cover is rolled up on the roller, it is contained within the roller construct. The cover is unrolled from the roller to provide cover or shade as described herein.

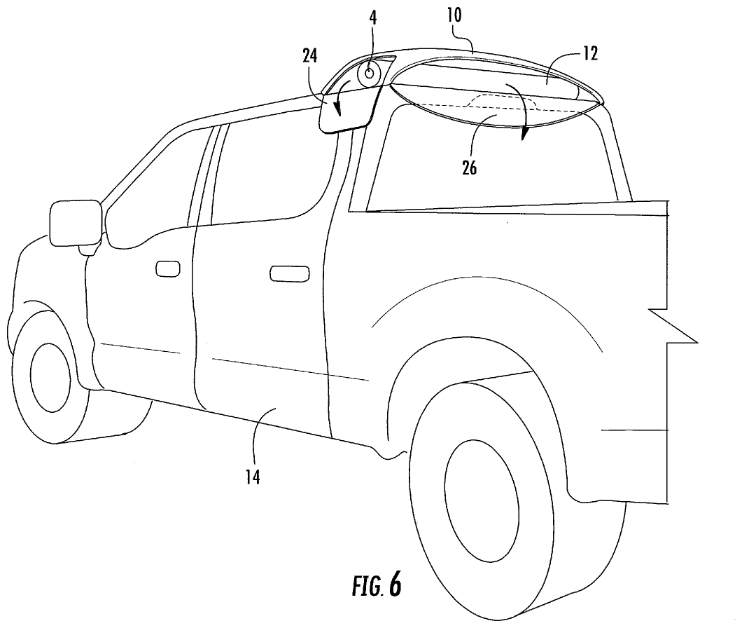

The roller construct is constructed to engages a track 12. The roller construct slides relative to the track. The track is mounted to a vehicle 14 and in a fixed position on the vehicle. Most commonly, according to a mode of using the invention, the track is mounted to a cab of a vehicle, typically above the portion of the cab in which the seats of the vehicle are located. The track is fixed to the vehicle, with the roller construct engaging the track in a slidable manner that allows the roller construct to the moved along the track. As shown in FIGS. 5 and 7, a majority, or entirety, of the roller 4 is repositioned outwardly from the vehicle to a side of the vehicle and exterior to the vehicle.

As shown in FIG. 1, in a first position where the roller construct is demonstrated as positioned over the cab of the vehicle 14, the cover 2 may be extended rearwardly relative to the vehicle to cover the rear of the vehicle, most commonly, a bed of a truck. See also FIG. 4.

In a second position, as shown in FIG. 5, the roller construct is moved outwardly along the track 12. The cover 2 is unfurled to extend toward a rear of the vehicle 14 to provide shade to a side of the vehicle, like an awning.

With the roller construct positioned over the vehicle (FIG. 4) or to a side of the vehicle (FIG. 5), the cover 2 is extended toward the rear of the vehicle 14. The cover is extended to the rear of the vehicle by causing the roller of the roller construct to rotate in a direction that will allow the cover to unroll or unfurl from the roller.

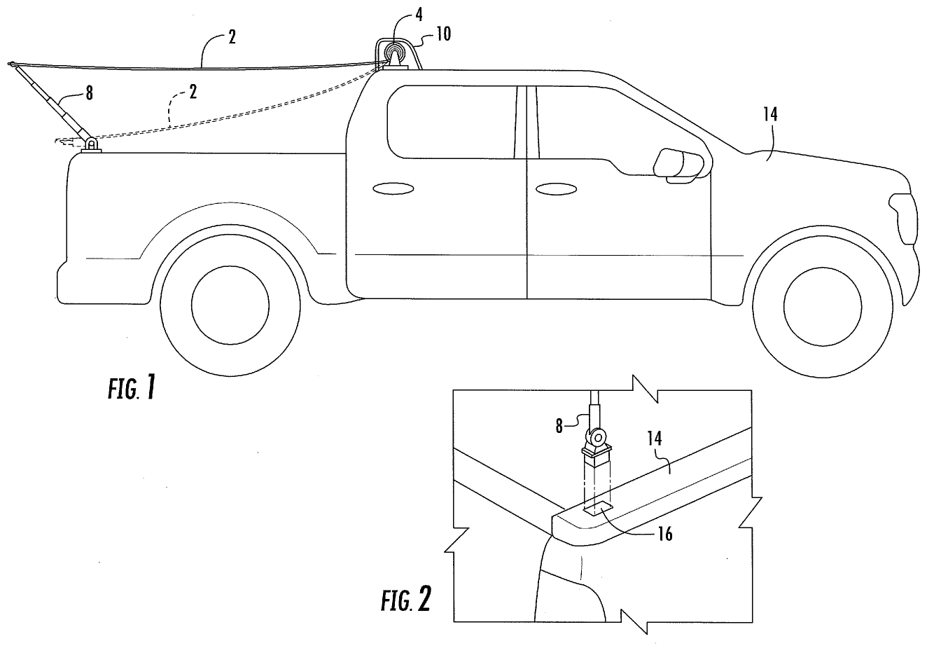

It is desirable to secure the cover 2 at a position that is opposite the roller construct after the cover is unrolled. In a preferred embodiment, a pair of length adjustable support members 6, 8 are mounted to the vehicle preferably at or near a rear end of the vehicle. When the roller construct and cover are in the position shown in FIG. 4, a first length adjustable support member 6 and a second length adjustable support member 8 are used. The length adjustable support members are spaced apart from each other in one embodiment. Commonly, the support members are positioned on each side of a bed of a truck. FIG. 4. Most pickup trucks have voids 16 formed in an upper surface of the sides of the beds of the pickup truck. In one embodiment, the support members are constructed and arranged for insertion into the voids. FIG. 2.

When the roller construct and cover 2 are positioned as shown in FIG. 5, the first length adjustable support member 6 and the second length adjustable support member 8 are attached at or near an end of the cover that is opposite the roller construct. In this position, the support members are located with a lower end of each of the support members adjacent to each other. As shown in FIG. 5, lower ends of the support members that are next to the mounting of the support members to the truck bed are side by side or adjacent to each other. The length adjustable support members typically share the same mounting void of the truck bed, such as the void 16 formed in the upper surface of the bed of the truck. A support member may be formed having two length adjustable members that move independently of each other with regard to articulation and with regard to length to support the cover in the position shown in FIG. 5.

One of the support members 8 as shown in FIG. 5 extends outwardly beyond the side of the truck. The ends of the support member that extends outwardly from the side of the truck attaches at or near one side of the end 18 of the cover 2 and the opposite support member 6 attaches at or near the other side of the end 20 of the cover.

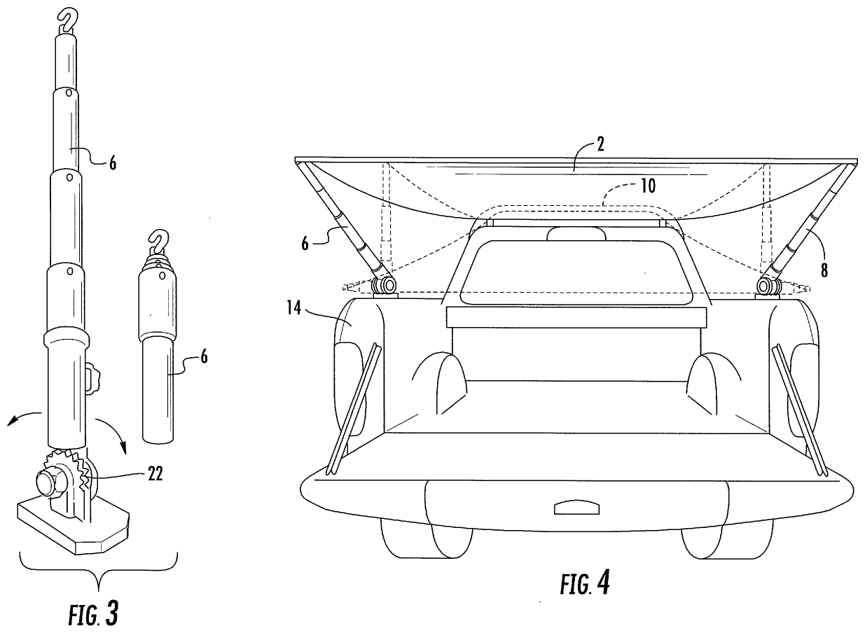

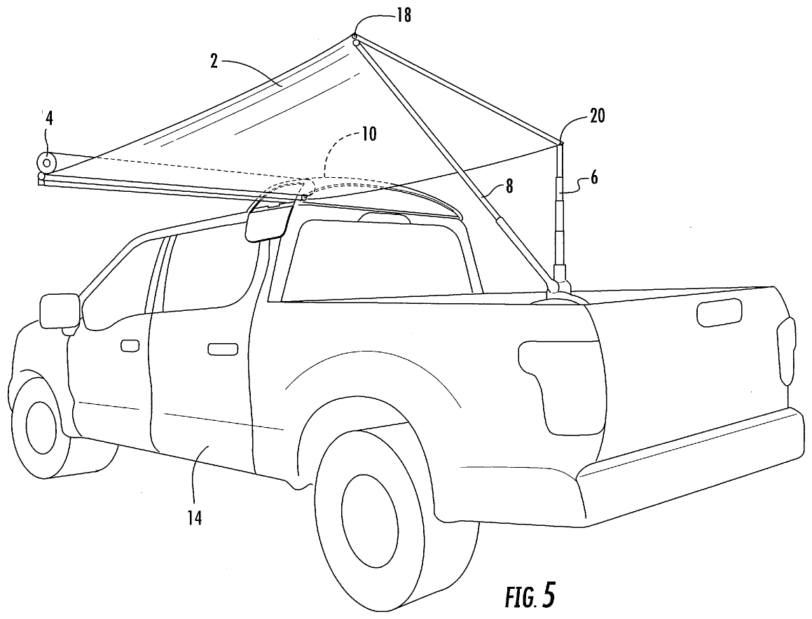

In each embodiment, it is preferred that the support members 6,8 are length adjustable. A telescoping member may be used. The telescoping feature allows the support member to be adjusted to a desired length. It is also preferred that the support members rotate about a fixed point near where the support member is mounted to the vehicle, as demonstrated by arrows in FIG. 3. The articulating and length adjustable support members allow for variable positioning of the cover.

In one embodiment, and as shown in FIG. 3, the support member may be rotated about an indexable mount 22 having teeth that engage each other. A threaded member may be provided to tightened and fix the support member at the desired, indexed location. It is also preferred that the base of the support member rotates, so that the support member rotates in a horizontal plane at a lower end so that the length adjustable support members are adjustable in three (x,y,z) axes.

As also demonstrated in FIG. 3, the length adjustable support members may be collapsed or expanded for length adjustment. Supports that provide selectable length are known.

By permitting rotation of the support members 6,8 in two axes, and making the support members length adjustable, substantial flexibility is provided in positioning the cover 2. In combination with the slideable mounting of the roller construct, the cover may be positioned for multiple uses with most trucks and similar vehicles, and particularly pickup trucks.

As shown in FIG. 1, the length of the support members may be reduced so that the cover 2 drapes more closely over the bed of the vehicle 14 to retain contents within the bed. Rotating the support member toward the front of the vehicle, where rotating the support members inwardly may provide even more draping or desired positioning.

The track 12 may be permanently fixed to the vehicle 14. In one embodiment, the track is temporarily fixed, such as with magnets or with a plurality of suction cups. The track may be positioned within or formed as part of a housing 10 that protects the roller construct. A door 26 of the housing permits the cover 2 to be unrolled to exit the housing for the configuration shown in FIG. 4 In another embodiment, a door 24 on the side of the housing allows the roller construct to the moved outwardly or laterally to the position shown in FIG. 5. In yet another embodiment the housing, cover and roller 4 move laterally outwardly as a unit as shown in FIG. 7. In the embodiment shown in FIG. 7, it is not necessary for the user to extract the roller mechanism from the housing. The user need only push the housing and the roller and cover move with the housing. Particularly in this latter embodiment, a locking mechanism is employed to keep the housing from sliding laterally when the cover is not extended and the vehicle is in motion. One skilled in the art is able to provide a device to secure the cover and roller assembly, such as a pin that is inserted into void that is affixed to the vehicle.

Temporary mounting of the track 12 and/or housing along with mounting for the support members 6, 8 in existing voids 16 formed in the beds of most pickup trucks with the support members removably positioned within the voids allows the device to be removed from the vehicle or placed on the vehicle, as desired.

The roller mechanism may be spring biased, similar to window shades that are spring biased so that the cover 2 can be unfurled from the roller 4 and then furled again by spring biasing of the roller. The useable length of the cover may be selected and positioned as window shades are used.

In another embodiment, an electric motor is used to furl and unfurl the cover 2 from the roller 4. If the device is temporarily mounted to the vehicle, the motor may be battery powered, such as by a plurality of D-cell batteries. If the device is permanently mounted to the vehicle, a motor may be connected to the electrical system of the vehicle. A remote control may be used to actuate the electric motor in one embodiment

In yet another embodiment, a cover may be unfurled simply by pulling the cover 2 relative to the roller 4. A detachable hand crank may be provided for furling or rolling the cover onto the roller.

What is claimed:

1. A cover usable with a vehicle, comprising:
a) a track,
b) a roller construct slidably mounted to the track, the roller construct comprising a roller,
c) a cover that rolls and unrolls about the roller construct,
d) a length adjustable support member that is spaced apart from the roller construct and is connectable to the cover;
wherein the roller construct is slidable laterally relative to the track.

2. A cover usable with a vehicle as described in claim 1, wherein the length adjustable support member rotates about a fixed point and in two axes.

3. A cover usable with a vehicle as described in claim 1, wherein the length adjustable support member rotates about a fixed point and in two axes, and further comprising a second length adjustable support member that is spaced apart from the roller construct and is connected to the cover.

4. A cover usable with a vehicle as described in claim 1, wherein the length adjustable support member rotates about a fixed point and in two axes, and further comprising a second length adjustable support member that is spaced apart from the roller construct and is connected to the cover, wherein the second length adjustable support member is positioned adjacent to the length adjustable support member.

5. A cover usable with a vehicle as described in claim 1, wherein the length adjustable support member rotates about a fixed point and in two axes, and further comprising a second length adjustable support member that is spaced apart from the roller construct and is connected to the cover, wherein the second length adjustable support member is spaced apart from the adjustable support member.

6. A cover usable with a vehicle as described in claim 1, wherein the roller construct slides laterally to a first side of the track.

7. A cover usable with a vehicle as described in claim 1, wherein the roller construct is slidable laterally to a first side of the track and laterally to an opposite side of the track.

8. A cover usable with a vehicle as described in claim 1, wherein the track is mounted over a cab of a vehicle and the roller construct is slidable laterally beyond a side of the vehicle.

9. A cover usable with a vehicle as described in claim 1, wherein the track is mounted over a cab of a vehicle and the roller construct is slidable beyond a side of the vehicle, and wherein an upper end of the length adjustable support member extends beyond a side of the vehicle.

10. A cover usable with a vehicle as described in claim 4, wherein the track is mounted over a cab of a vehicle and the roller construct is slidable laterally beyond a side of the vehicle, and wherein an upper end of the length adjustable support member extends beyond a side of the vehicle.

11. A cover usable with a vehicle as described in claim 1, wherein the length adjustable support member is mounted near a rear of the vehicle.

12. A cover usable with a vehicle as described in claim 1, wherein the track is positioned inside a housing having a fixed position and the roller construct is slidable laterally from a position inside the housing to a position that is outside the housing.

13. A cover usable with a vehicle as described in claim 1, wherein the track is positioned inside a housing at a first position and the roller construct and housing are slidable laterally from a first position to a second position wherein the track is outside the housing.

14. A cover usable with a vehicle as described in claim 1, wherein the track is mounted in a fixed position and is inside a housing in a first position and the roller construct and housing are slidable laterally from a first position to a second position wherein the track is outside the housing.
